(19) United States
(12) Patent Application Publication
(10) Pub. No.: US 2026/0122208 A1
(43) Pub. Date: Apr. 30, 2026

(54) ELECTRONIC APPARATUS AND METHOD FOR CONTROLLING THEREOF

(71) Applicant: SAMSUNG ELECTRONICS CO., LTD., Suwon-si (KR)

(72) Inventors: Dongho LEE, Suwon-si (KR); Soohyun WHANG, Suwon-si (KR); Sunyoung KIM, Suwon-si (KR); Jongpil KIM, Suwon-si (KR); Dajeong SIM, Suwon-si (KR)

(73) Assignee: SAMSUNG ELECTRONICS CO., LTD., Suwon-si (KR)

(21) Appl. No.: 19/307,859

(22) Filed: Aug. 22, 2025

Related U.S. Application Data
(63) Continuation of application No. PCT/KR2025/011360, filed on Jul. 30, 2025.

(30) Foreign Application Priority Data
Oct. 24, 2024 (KR) 10-2024-0146494

(51) Int. Cl. H04N 13/122; G06F 3/04815; H04N 13/111; H04N 13/133

(52) U.S. Cl. CPC H04N 13/122; G06F 3/04815; H04N 13/111; G06F 2203/04804; H04N 13/133

(57) ABSTRACT

An electronic apparatus may include: a sensor configured to obtain ambient information of a transparent display; memory configured to store at least one instruction; and at least one processor, wherein the at least one instruction, when executed by the at least one processor individually or collectively, causes the electronic apparatus to: obtain masking information corresponding to a real object adjacent to the transparent display based on the ambient information; obtain a virtual object image to be displayed on the transparent display; generate a display image to be displayed on the transparent display by correcting a shape of the virtual object image based on the masking information; and output the display image to the transparent display.

### CROSS-REFERENCE TO RELATED APPLICATIONS

This application is a bypass continuation application of international application No. PCT/KR2025/011360, filed Jul. 30, 2025, which claims priority to Korean Patent Application No. 10-2024-0146494, filed Oct. 24, 2024, the disclosures of which are incorporated herein by reference in their entireties.

### BACKGROUND

### 1. Field

The disclosure relates to an electronic apparatus that can display a virtual object to be displayed on a transparent display based on an ambient object, and a method for controlling thereof.

### 2. Description of Related Art

Fueled by development of electronic technologies, various types of display apparatuses are being used in various fields. In particular, recently, research and discussion on next-generation display apparatuses such as a transparent display apparatus are accelerating.

A transparent display apparatus means an apparatus that has a transparent property, and thus the background on the rear side of the apparatus is seen through as it is. In the past, display panels were manufactured using an opaque semiconductor compound such as silicon (Si), gallium arsenide (GaAs), etc. However, certain applications are not suited for conventional display panels, and there have been efforts to develop new types of displays, such as transparent displays.

### SUMMARY

The embodiments of the disclosure can resolve at least one problem and/or disadvantage explained above, and provide advantages that will be described below. Accordingly, the purpose of the embodiments of the disclosure is in providing an electronic apparatus that can display a virtual object to be displayed on a transparent display based on an ambient object, and a method for controlling thereof.

Also, additional embodiments will be presented in the detailed description of the invention that will be described below, and some of the embodiments will be obvious from the detailed description of the invention, and other embodiments may also be suggested through learning from the suggested embodiments.

According to an aspect of the disclosure, an electronic apparatus may include: a sensor configured to obtain ambient information of a transparent display; memory configured to store at least one instruction; and at least one processor, wherein the at least one instruction, when executed by the at least one processor individually or collectively, causes the electronic apparatus to: obtain masking information corresponding to a real object adjacent to the transparent display based on the ambient information; obtain a virtual object image to be displayed on the transparent display; generate a display image to be displayed on the transparent display by correcting a shape of the virtual object image based on the masking information; and output the display image to the transparent display.

The at least one instruction, when executed by the at least one processor individually or collectively, may further causes the electronic apparatus to: identify a type of the real object; and obtain the virtual object image corresponding to the type.

The at least one instruction, when executed by the at least one processor individually or collectively, may further causes the electronic apparatus to: identify movement of the real object; and obtain the virtual object image in which at least one of a location or the shape of a virtual object is changed based on the movement of the real object.

The sensor may include a camera configured to image a rear side of the transparent display. The at least one instruction, when executed by the at least one processor individually or collectively, may further causes the electronic apparatus to: identify the real object for which the masking information will be obtained by using an image taken at the camera; and obtain layout information corresponding to a shape of the real object.

The sensor may include: a camera on at least one of an upper part, a left side surface, or a right side surface of the transparent display, and takes an image in a direction of a center part of the transparent display. The at least one instruction, when executed by the at least one processor individually or collectively, may further cause the electronic apparatus to: identify the real object located within a frame space supporting the transparent display, and obtain layout information corresponding to a shape of the real object.

The at least one instruction, when executed by the at least one processor individually or collectively, may further cause the electronic apparatus to: obtain a layout image corresponding to a shape of the real object; and obtain a masking layout by scaling the layout image based on size information of the real object.

The at least one instruction, when executed by the at least one processor individually or collectively, may further causes the electronic apparatus to: generate the display image with a virtual object extending from a location of the real object based on the masking information.

The at least one instruction, when executed by the at least one processor individually or collectively, may further causes the electronic apparatus to: generate the display image with a size of a virtual object adjusted based on an arrangement of the virtual object and the real object.

The at least one instruction, when executed by the at least one processor individually or collectively, may further cause the electronic apparatus to: based on a virtual object being arranged behind the real object, generate the display image with an area in the virtual object overlapping with the real object not displayed.

The at least one instruction, when executed by the at least one processor individually or collectively, may further cause the electronic apparatus to: obtain the masking information corresponding to a color area having color information of the real object; and obtain a color filter image that makes the color area of the virtual object image appear a different color from the color information.

The masking information may include area information where the virtual object image is displayed, and the area information may be an ambient area excluding the real object. The at least one instruction, when executed by the at least one processor individually or collectively, may further cause the electronic apparatus to: obtain an event image with an image filter applied to the ambient area using the masking information.

The masking information may include area information where the virtual object image is displayed, and the area information is an object area including the real object. The at least one instruction, when executed by the at least one processor individually or collectively, may further cause the electronic apparatus to: obtain an event image with an image filter applied to the object area using the masking information.

The electronic apparatus may further include: the transparent display. The at least one instruction, when executed by the at least one processor individually or collectively, may further cause the electronic apparatus to: control the transparent display to display the display image.

According to an aspect of the disclosure, a method for controlling an electronic apparatus, may include, using at least one processor: obtaining ambient information of a transparent display from a sensor; obtaining masking information corresponding to a real object adjacent to the transparent display based on the ambient information; obtaining a virtual object image to be displayed on the transparent display; generating a display image to be displayed on the transparent display by correcting a shape of the virtual object image based on the masking information; and outputting the display image to the transparent display.

According to an aspect of the disclosure, a non-transitory computer-readable recording medium storing a program for executing a method for controlling an electronic apparatus, wherein the method may include: obtaining ambient information of a transparent display; obtaining masking information corresponding to a real object adjacent to the transparent display based on the ambient information; obtaining a virtual object image to be displayed on the transparent display; generating a display image to be displayed on the transparent display by correcting a shape of the virtual object image based on the masking information; and outputting the display image to the transparent display.

The method may further include, using the at least one processor: identifying a type of the real object; and obtaining the virtual object image corresponding to the type.

The method may further include, using the at least one processor: identifying movement of the real object; and obtaining the virtual object image in which at least one of a location or the shape of a virtual object is changed based on the movement of the real object.

The sensor may include a camera configured to image a rear side of the transparent display. The method may further include, using the at least one processor: identifying the real object for which the masking information will be obtained by using an image taken at the camera; and obtaining layout information corresponding to a shape of the real object.

The sensor may include a camera on at least one of an upper part, a left side surface, or a right side surface of the transparent display, and takes an image in a direction of a center part of the transparent display. The method may further include, using the at least one processor: identifying the real object located within a frame space supporting the transparent display, and obtain layout information corresponding to a shape of the real object.

The method may further include, using the at least one processor: obtaining a layout image corresponding to a shape of the real object; and obtaining a masking layout by scaling the layout image based on size information of the real object.

### BRIEF DESCRIPTION OF DRAWINGS

The aforementioned or other aspects, characteristics, and advantages of the embodiments of the disclosure will become clearer from the following description with reference to the accompanying drawings. In the accompanying drawings:

FIG. 1 is a diagram for illustrating an operation of generating an image based on an ambient object of a transparent display apparatus according to one or more embodiments of the disclosure;

FIG. 2 is a block diagram illustrating a configuration of a transparent display according to one or more embodiments of the disclosure;

FIG. 3 is a block diagram illustrating a configuration of a transparent display according to one or more embodiments of the disclosure;

FIG. 4 is a diagram for illustrating a method of generating masking information according to one or more embodiments of the disclosure;

FIG. 5 is a diagram for illustrating a method of displaying a virtual object based on a real object according to one or more embodiments of the disclosure;

FIG. 6 is a diagram for illustrating a method of displaying a virtual object based on a real object according to one or more embodiments of the disclosure;

FIG. 7 is a diagram for illustrating a method of displaying a virtual object based on a real object according to one or more embodiments of the disclosure;

FIG. 8 is a diagram for illustrating one or more embodiments of utilizing masking information as filter information according to one or more embodiments of the disclosure;

FIG. 9 is a diagram for illustrating one or more embodiments of utilizing masking information as filter information according to one or more embodiments of the disclosure;

FIG. 10 is a diagram for illustrating one or more embodiments of utilizing masking information as filter information according to one or more embodiments of the disclosure;

FIG. 11 is a diagram for illustrating one or more embodiments of utilizing masking information as filter information according to one or more embodiments of the disclosure;

FIG. 12 is a diagram for illustrating an operation of displaying a 3D content according to one or more embodiments of the disclosure; and

FIG. 13 is a flow chart for illustrating a method for controlling an electronic apparatus according to one or more embodiments of the disclosure.

### DETAILED DESCRIPTION

Various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, but they should be interpreted to include various modifications, equivalents, and/or alternatives of the embodiments of the disclosure. Also, with respect to the detailed description of the drawings, similar components may be designated by similar reference numerals.

Also, in describing the disclosure, in case it is determined that detailed explanation of related known functions or features may unnecessarily obscure the gist of the disclosure, the detailed explanation will be omitted.

In addition, the embodiments described below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

Further, the terms used in the disclosure are used only to explain specific embodiments, and are not intended to limit the scope of the disclosure. Further, singular expressions include plural expressions, unless defined obviously differently in the context.

In addition, in the disclosure, expressions such as “have,” “may have,” “include,” and “may include” denote the existence of such characteristics (e.g.: elements such as numbers, functions, operations, and components), and do not exclude the existence of additional characteristics.

Also, in the disclosure, the expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including at least one A, (2) including at least one B, or (3) including at least one A and at least one B.

Further, the expressions “first,” “second,” and the like used in the disclosure may describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

In contrast, the description that one element (e.g.: a first element) is “directly coupled” or “directly connected” to another element (e.g.: a second element) can be interpreted to mean that still another element (e.g.: a third element) does not exist between the one element and the another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” may not necessarily mean that an apparatus is “specifically designed to” in terms of hardware.

Instead, under some circumstances, the expression “an apparatus configured to” may mean that the apparatus “is capable of” performing an operation together with another apparatus or component. For example, the phrase “a processor configured to perform A, B, and C” may mean a dedicated processor (e.g.: an embedded processor) for performing the corresponding operations, or a generic-purpose processor (e.g.: a CPU or an application processor) that can perform the corresponding operations by executing one or more software programs stored in a memory device.

Also, in the embodiments of the disclosure, ‘a module’ or ‘a unit’ may perform at least one function or operation, and may be implemented as hardware or software, or as a combination of hardware and software. Further, a plurality of ‘modules’ or ‘units’ may be integrated into at least one module and implemented as at least one processor, excluding ‘a module’ or ‘a unit’ that needs to be implemented as specific hardware.

In addition, operations performed by a module, a program, or other components according to the various embodiments may be executed sequentially, in parallel, repetitively, or heuristically. Or, at least some of the operations may be executed in a different order or omitted, or other operations may be added.

Meanwhile, various elements and areas in the drawings were illustrated schematically. Accordingly, the technical idea of the disclosure is not limited by the relative sizes or intervals illustrated in the accompanying drawings.

Meanwhile, an electronic apparatus according to the various embodiments of the disclosure may include, for example, at least one of a terminal device, a tablet PC, a desktop PC, a laptop PC, a server, or a wearable apparatus. Here, a wearable apparatus may include at least one of an accessory-type apparatus (e.g.: a watch, a ring, a bracelet, an ankle bracelet, a necklace, glasses, a contact lens, or a head-mounted-device (HMD)), an apparatus integrated with fabrics or clothing (e.g.: electronic clothing), a body-attached apparatus (e.g.: a skin pad or a tattoo), or an implantable circuit.

Also, in some embodiments, an electronic apparatus may include, for example, at least one of a television, a digital video disk (DVD) player, an audio, a refrigerator, an air conditioner, a cleaner, an oven, a microwave oven, a washing machine, an air purifier, a set top box, a home automation control panel, a security control panel, a media box (e.g.: Samsung HomeSync™, Apple TV™, or Google TV™), a game console (e.g.: Xbox™, PlayStation™), an electronic dictionary, an electronic key, a camcorder, or an electronic photo frame. Meanwhile, among the aforementioned electronic apparatuses, an apparatus including a display may be referred to as a display apparatus. Meanwhile, an electronic apparatus according to the disclosure may be a set top box or a PC that provides images to a display apparatus, even if it does not include a display.

Hereinafter, embodiments according to the disclosure will be described in detail with reference to the accompanying drawings, such that those having ordinary skill in the art to which the disclosure belongs can easily carry out the disclosure.

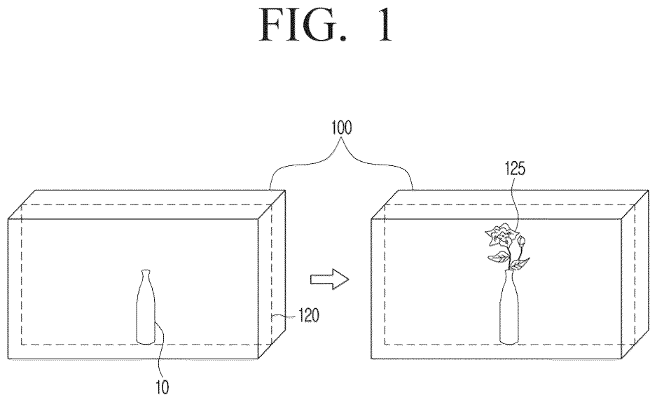

FIG. 1 is a diagram for illustrating an operation of generating an image based on an ambient object of a transparent display apparatus according to one or more embodiments of the disclosure.

Referring to FIG. 1, an electronic apparatus 100 may generate an image including a virtual object, and display the image through a transparent display. For example, it can be figured out that a real object 10 (e.g. a bottle or vase) is located around the transparent display 160, and an image 125 corresponding to a virtual object matching the real object 10 (e.g., a flower) is displayed in the upper part of the real object 10.

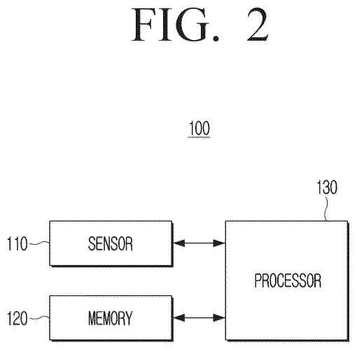

The transparent display 160 is a display wherein an object behind the screen visible because the display itself is transparent. The detailed configuration and operation of the transparent display 160 will be described later in FIG. 2.

Here, an object may be an abstract expression for an entity existing in the real world. Also, according to the embodiments of the disclosure, an object may include an object existing in the real world, or an object included in a photographed image. Alternatively, an object may include an object generated virtually within a content.

Hereinafter, a real object refers to an object that is distinguished from the electronic apparatus 100 and is arranged to be adjacent to the electronic apparatus 100. Also, a virtual object is an object expressed within an image, and the object within the image may have been generated by photographing a real object, or may have been generated virtually.

For example, an object may include not only a chair, a tree, and a car in the real world, but also an airplane included in a photographed image or a 3D character included in 3D animation. Meanwhile, an object may also be referred to as an entity, a thing, etc.

In a process of displaying a virtual object as above, the electronic apparatus 100 of the disclosure identifies an adjacent real object, and displays a virtual object in consideration of the identified object, and thus the user can have an experience with a higher degree of immersion.

Also, a content consists of an image, audio, or a combination thereof, and includes information that can be provided to the user visually, acoustically, or audiovisually through the electronic apparatus. For example, a content may include a voice content, a music content, an image content, a video content, a widget content, a web page, etc.

Meanwhile, in order to display a virtual object to match a real object, the electronic apparatus 100 should be correctly aware of the location of the real object, and immersive display of an image is possible when the virtual object is displayed in a correct location.

For example, in an environment as in FIG. 1, if the image 125 (e.g. a flower) is displayed in a location higher than the vase by a specific degree, the user may not feel a sense of reality that the flower is contained in the vase. Also, in case a very small vase is located, and a flower bigger than the vase by several times is located in the upper part, it is difficult for the user to feel a sense of reality.

That is, in order to display a virtual object in association with a real object, the real object should be identified correctly, and the location of the identified real object should be recognized correctly by the electronic apparatus, and in that case, the virtual object can be displayed in association with the real object.

For such an operation, masking information is used in the disclosure. Specifically, the electronic apparatus 100 can identify a real object located around the transparent display apparatus. For example, the electronic apparatus 100 can identify a predetermined object among a real object located within a frame fixing the transparent display, or a real object located on the rear side of the transparent display. That is, information on a predetermined object as above may be stored in advance in the electronic apparatus 100. Here, information on the real object and information on a virtual object corresponding to the object may be stored.

Here, the masking information is information regarding the form that a real object in a real space is displayed on the transparent display. In image synthesis and processing that will be described below, image processing may be performed in consideration of only the size and shape information within the mask.

Then, the electronic apparatus 100 may generate a virtual object by using the masking information generated in the aforementioned process. For example, the electronic apparatus 100 may generate a virtual object to be displayed based on the type of a real object included in the masking information.

Then, the electronic apparatus 100 may modify the shape of the virtual object image based on the masking information and generate an image to be displayed on the transparent display, and display the generated image on the transparent display 160. The specific configuration and operation of the electronic apparatus 100 will be described later with reference to FIG. 2.

As described above, in the disclosure, the electronic apparatus operates in consideration of a real object around the transparent display in a process of displaying a virtual object, and thus a display operation of a virtual object that matches the ambient environment is possible. Also, in the aforementioned display process, masking information corresponding to a real object is generated, and thus generation of a virtual object and generation of an image matching the real object can be performed easily without a complex calculation operation.

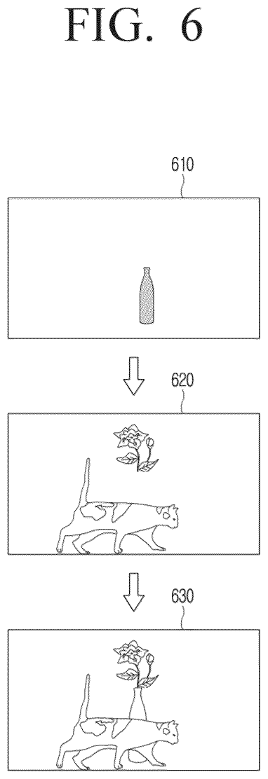

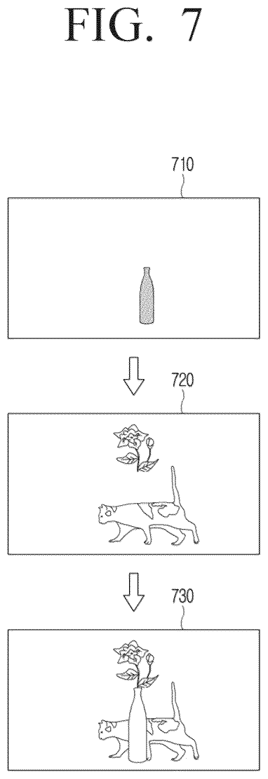

Meanwhile, in FIG. 1, the disclosure was illustrated and explained in consideration of a state wherein both of a real object and a virtual object are static, but in actual implementation, even if a real object is fixed, a virtual object may be an object that moves dynamically. Explanation in this regard will be described later with reference to FIG. 6 and FIG. 7. Also, a real object may not be a static object such as a thing, but may be a dynamic object such as a person, an animal, and a moving object, and in this case, an object displayed in association may also be a dynamic object.

For example, in case the transparent display illustrated is located on a window, in response to movement of an airplane or a car behind the window, it is possible to display various virtual objects such as displaying cloud correspondingly to the moving path of the airplane or the car.

Meanwhile, in the illustrated example, explanation was described by assuming that the electronic apparatus 100 displays an image by itself, for making explanation easy, but in actual implementation, the electronic apparatus 100 may be an apparatus that does not include a transparent display, and outputs an image on another apparatus.

Meanwhile, in FIG. 1, it was illustrated and explained that only one transparent display is included within the frame, but in actual implementation, a plurality of displays may be included within the frame. In this case, all of the plurality of displays may be transparent displays, or at least one display may be an opaque display (i.e., a general display).

FIG. 2 is a block diagram illustrating a configuration of a transparent display according to one or more embodiments of the disclosure.

Referring to FIG. 2, the electronic apparatus 100 may include a sensor 110, memory 120, and a processor 130.

The sensor 110 obtains ambient information of the transparent display. For example, the sensor 110 may be a camera. Such a camera may be arranged in the direction of the rear side of the transparent display, and obtain an image corresponding to the background of the transparent display. Here, the background may be seen in case the user views the transparent display when the transparent display does not display any image.

Photographing according to one or more embodiments of the disclosure may include an operation of the electronic apparatus of controlling a camera (e.g., a camera including an image sensor and a lens) provided on the electronic apparatus and converting an optical image formed through a lens into an electric signal, and thereby obtaining an image. In other words, photographing may include taking an image using at least one camera. Here, the image may include a live-view image. Such an image (or, a video) may include various forms of visual information. As an example, the image may include a still image and a dynamic image (or, a video).

A video according to one or more embodiments of the disclosure may include various forms of visual information indicating movement of a thing (or an object) by using a plurality of consecutive still images.

An image according to one or more embodiments may include a photographed image obtained by using a sensor (e.g., a camera) provided on the electronic apparatus, an input image received from an external apparatus through a communication interface, a graphic image generated by the electronic apparatus, etc.

Also, an image according to one or more embodiments may include a horizontal image wherein the width is longer than the height (e.g., a landscape image, a horizontal image), a vertical image wherein the height is longer than the width (e.g., a portrait image, a vertical image), etc. according to ratios. As an example, a horizontal image may include an image of a ratio of 16:9, and a vertical image may include an image of a ratio of 9:16. However, the specific numbers are merely an example for the convenience of explanation, and the disclosure is obviously not limited thereto.

In addition, an image according to one or more embodiments may include various resolutions according to the number of pixels constituting an image (a multiplication of the number of pixels in a horizontal direction and the number of pixels in a vertical direction).

For example, an image may include an image of a high resolution (FHD (1920×1080), 8K (7680×4320), etc.) and an image of a low resolution (640×480, etc.) and the like according to resolutions.

According to one or more embodiments of the disclosure, each of a plurality of still images included in a video may mean a frame (or, an image frame).

According to one or more embodiments, a video consists of a plurality of frames, and each of the plurality of frames may correspond to one screen output by the electronic apparatus. According to one or more embodiments, the number of frames (or, the number of screens) output by the electronic apparatus during one second is referred to as a frame rate, and a frame rate can be expressed in a unit of frames per second (fps) or Hertz (Hz). According to one or more embodiments, a video of 60 fps may mean a video including 60 frames during 1000 ms.

A foreground may include a part that is main or central in an image.

The foreground may include a major part according to a predetermined intent or the user's intent. The foreground may include an area of interest among the entire areas of the image. The foreground may include a part that is visually important in the image. The foreground may include information (or characteristics) corresponding to the predetermined intent or the user's intent. As the foreground is distinguished from the background, it may include information corresponding to the intent. The foreground may include target information corresponding to the intent.

For example, the foreground may include an area of interest, an object of interest, an object area, a target area, a target object, a subject, etc.

A background may include a part that is not main or not central in an image.

The background may include an ambient area of an object that becomes the center in the image. The background may include areas excluding an area of interest among the entire areas. As the background is distinguished from the foreground, it may include information not corresponding to the intent. The background may not include target information corresponding to the intent.

For example, the background may include a background area, an ambient area, an auxiliary area, etc.

According to various embodiments, an area indicating the background may be used as a main area based on a predetermined intent or the user's intent.

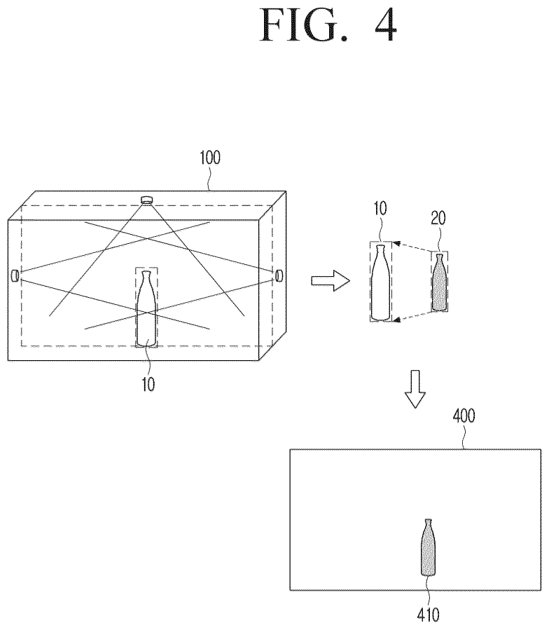

Also, the sensor 110 may be a camera that photographs an object located in a space inside the frame supporting the transparent display. In this case, the camera may be one, and may have been arranged in the direction toward the inside of the frame from a plurality of directions. Also, in actual implementation, the sensor may be a distance sensor, etc. but not a camera. The specific form of the sensor 110 will be described later in FIG. 4.

The sensor 110 may identify the location of the user. That is, the sensor 110 may identify how far the user is located, and in which direction the user is located based on the transparent display. A camera may be used for such detection of the user's location, or a distance sensor or a UWB communicating with a user terminal apparatus may be used.

The memory 120 may be implemented as internal memory such as ROM (e.g., electrically erasable programmable read-only memory (EEPROM)), RAM, etc., included in the processor 130, or implemented as separate memory from the processor 130. In this case, the memory 120 may be implemented in the form of memory embedded in the electronic apparatus 100, or implemented in the form of memory that can be attached to or detached from the electronic apparatus 100 according to the use of stored data. For example, in the case of data for driving the electronic apparatus 100, the data may be stored in memory embedded in the electronic apparatus 100, and in the case of data for an extended function of the electronic apparatus 100, the data may be stored in memory that can be attached to or detached from the electronic apparatus 100.

The memory 120 may store information detected in the sensor, or store masking information generated in a process that will be described below. Also, the memory 120 may store information corresponding to a virtual object and mapping information between a real object and a virtual object, etc.

The memory 120 may temporarily store an image generated in a process that will be described below.

Meanwhile, the memory embedded in the electronic apparatus 100 may be implemented as at least one of volatile memory (e.g.: dynamic RAM (DRAM), static RAM (SRAM), or synchronous dynamic RAM (SDRAM), etc.) or non-volatile memory (e.g.: one time programmable ROM (OTPROM), programmable ROM (PROM), erasable and programmable ROM (EPROM), electrically erasable and programmable ROM (EEPROM), mask ROM, flash ROM, flash memory (e.g.: NAND flash or NOR flash, etc.), a hard drive, or a solid state drive (SSD)). Also, the memory that can be attached to or detached from the electronic apparatus 100 may be implemented in forms such as a memory card (e.g., compact flash (CF), secure digital (SD), micro secure digital (Micro-SD), mini secure digital (Mini-SD), extreme digital (xD), a multi-media card (MMC), etc.) and external memory that can be connected to a USB port (e.g., a USB memory), etc.

The memory 120 may store at least one instruction related to various types of operations. Here, an instruction may mean a small task unit executed in the processor. Also, an instruction may include an instruction for generating masking information, an instruction for generating an image corresponding to a virtual object, an instruction for controlling the transparent display, etc.

Meanwhile, in the illustrated example, it was illustrated that the electronic apparatus 100 consists of one memory, but in the case of referring to memories by distinguishing a volatile memory and a non-volatile memory, it may be described that the electronic apparatus 100 includes a plurality of memories.

The processor 130 may perform overall control operations of the electronic apparatus 100. Specifically, the processor 130 performs a function of controlling the overall operations of the electronic apparatus 100.

The processor 130 may be implemented as a digital signal processor (DSP) processing digital signals, a microprocessor, and a time controller (TCON). However, the disclosure is not limited thereto, and the processor 130 may include one or more of a central processing unit (CPU), a micro controller unit (MCU), a micro processing unit (MPU), a controller, an application processor (AP), a graphics-processing unit (GPU) or a communication processor (CP), and an ARM processor, or may be defined by the terms. Also, the processor 130 may be implemented as a system on chip (SoC) having a processing algorithm stored therein or large scale integration (LSI), or implemented in the form of a field programmable gate array (FPGA). In addition, the processor 130 may perform various functions by executing computer executable instructions stored in the memory. Meanwhile, in FIG. 2, it was illustrated that the electronic apparatus 100 includes only one processor, but in actual implementation, the electronic apparatus 100 may include a plurality of processors (e.g., a CPU+a GPU, a CPU+a DSP).

The processor 130 obtains ambient information of the transparent display. For example, regarding an object located within the frame supporting the transparent display, the processor 130 may be arranged in at least one location among the upper part, the left side surface, or the right side surface of the frame, and obtain ambient information by using an image obtained at the camera photographing in the central direction.

The processor 130 may photograph the rear side direction of the transparent display, and obtain ambient information regarding the rear side direction of the transparent display. Meanwhile, in actual implementation, the processor 130 may obtain only information for a partial space among two spaces. Alternatively, the processor 130 may obtain information for both of the two spaces.

The processor 130 may obtain user location information. For example, the processor 130 may photograph the front side of the transparent display, and obtain information on the location and the distance, etc. of the user based on the location of the screen of the transparent display.

The processor 130 obtains masking information corresponding to a real object adjacent to the transparent display based on the ambient information. For example, the processor 130 may obtain a layout image corresponding to the shape of the real object, and obtain a masking layout by scaling the layout image based on the size information of the real object seen on the transparent display.

Here, the layout may be a state wherein various graphic elements (e.g., texts, images, etc.) are arranged within the screen of the electronic apparatus. According to one or more embodiments of the disclosure, the layout may include information that designated the sizes, the forms, the arrangement locations, the arrangement order, etc. of areas for displaying various types of information.

Then, the processor 130 may identify a real object for which masking information will be obtained by using a photographed image, and obtain layout information corresponding to the shape of the identified real object.

For example, as various objects may exist in a real environment, the processor 130 may select an object to which the disclosure will be applied by priority, and generate masking information having a mask layer for the selected object.

Here, the masking information may include at least one of type information, layout information, or location information of the real object. Here, the type information may be a result of recognizing an object for the real object and may be the name of the type, and may be expressed as a code value, etc. The layout information may be an image of the shape of the real object projected on the transparent display, as will be described later in FIG. 4. Also, the location information may include information on the distance with the transparent display, etc.

Here, the processor 130 may obtain the information on the type and the shape, etc. of the real object adjacent to the transparent display based on the ambient information.

Then, the processor 130 obtains a virtual object image to be displayed on the transparent display. For example, the processor 130 may obtain a virtual object image corresponding to the identified real object (or the type of the real object). For example, if the adjacent real object is a flowerpot (or a vase), the processor 130 may obtain a virtual object image related to a flower as a virtual object. Also, if the adjacent real object is a fish bowl, fish may be used as a virtual object.

However, these are merely examples, and in actual implementation, a plurality of virtual objects but not one virtual object may be used.

Here, in a process of obtaining the aforementioned real object image, the processor 130 may obtain a virtual object image in consideration of the user's location. For example, like a case wherein the user is located on the front side, and a case wherein the user is located to be inclined to the side, a space wherein the real object is projected on the transparent display may be different according to the location of the user. Accordingly, the processor 130 may obtain the aforementioned virtual object image in consideration of the user's location.

Meanwhile, in case a plurality of users exist, the processor 130 may generate the aforementioned virtual object image by considering the locations of several users among the plurality of users, or assuming that the users are located on the front side.

Then, if movement of the real object is identified, the processor 130 may obtain a virtual object image wherein at least one of the location or the shape of the virtual object is changed based on information on the identified movement of the real object. For example, if the real object is a cat, the virtual object may be a cat toy.

In this case, the virtual object may move in the same direction correspondingly to the direction in which the cat moves. Alternatively, in case the real flowerpot moves, the processor 130 may generate a virtual object image wherein the flower object moved correspondingly to the movement of the flowerpot. Also, the processor 130 may create a situation wherein petals flutter or fall, etc. correspondingly to the moving direction and speed.

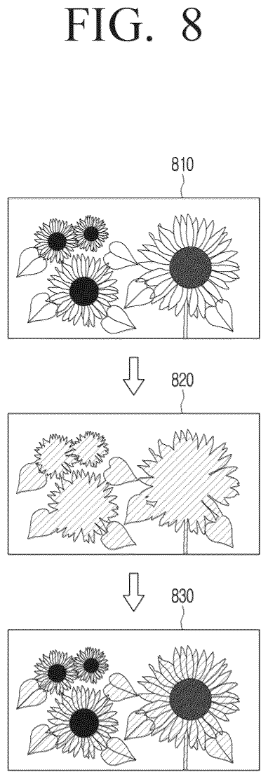

Then, the processor 130 may obtain masking information corresponding to a color area having predetermined color information in the real object, and obtain a color filter image that makes the color area of the virtual object image seen in a different color from the color information. Examples as above will be described later in FIG. 8 to FIG. 11.

An operation as above may be referred to as color correction for an area of a real object. Meanwhile, according to one or more embodiments of the disclosure, main attributes of a color may include a hue, brightness, and chroma.

According to one or more embodiments, the hue may include the name of the color. The brightness may include the degree of brightness and darkness of the color. The chroma may include the degree that the color is clear.

According to one or more embodiments, a tone may include a combination of brightness and chroma. For example, if a tone is high, a bright and clear color may be included as the brightness and the chroma are high, and if a tone is low, a dark and murky color may be included as the brightness and the chroma are low.

According to one or more embodiments, a color gamut (alternatively, a color area, a color reproduction rate) may include a degree that colors of an image can be reproduced on a screen output on the display, and a range of colors that can be expressed by the display. As an example, a color gamut can be expressed in a percentage based on color specifications such as NTSC, sRGB, Adobe RGB, DCI-P3, etc. in a CIE color coordinate system.

A contrast (or, a contrast ratio) according to one or more embodiments of the disclosure may indicate a difference between the brightest area and the darkest area in an image output on the display. For example, a contrast may include a value that expressed a difference between the maximum luminance (e.g., white) and the minimum luminance (e.g., black) of the display as a numerical value.

According to one or more embodiments of the disclosure, the width of a contrast may include a dynamic range (DR). Also, according to one or more embodiments, the display may obtain a high dynamic range (HDR) image by widening the contrast ratio of an image. For example, the display may obtain an HDR image wherein the contrast has been maximized by increasing a difference between a relatively bright area and a relatively dark area within the image.

Accordingly, correction of a color as explained above can also be applied to a contrast, chroma, etc.

If the masking information is for an ambient area excluding a predetermined real object, the processor 130 may obtain an event image wherein an effect of applying a predetermined image filter to the ambient area exists by using the masking information.

Also, the processor 130 may obtain an event image wherein an effect of applying a predetermined image filter to the object area exists by using the masking information.

The processor 130 generates an image to be displayed on the transparent display by correcting the shape of a virtual object image based on the masking information. Specifically, the processor 130 may generate an image wherein the size of a virtual object was adjusted based on the arrangement form of the virtual object and the real object. Then, in case the virtual object is arranged behind the real object, the processor 130 may generate an image wherein an area in the virtual object overlapping with the real object is not displayed.

Then, when the aforementioned image is generated, the processor 130 may provide the generated image to the transparent display. Meanwhile, in actual implementation, the electronic apparatus may be an apparatus distinguished from the transparent display. In this case, the image generated through the aforementioned process may be transmitted to the transparent display apparatus.

Meanwhile, in case the electronic apparatus 100 includes an additional display, the electronic apparatus 100 may control the additional display such that an image for the display is displayed. For example, in case the electronic apparatus includes a plurality of transparent displays, the processor 130 may generate images to be displayed on each transparent display, and make the images displayed on each transparent display.

As described above, in the controlling method according to the disclosure, a virtual object is displayed by utilizing an object located around the transparent display apparatus, and thus more realistic display of a content is possible.

Also, as described above, the electronic apparatus according to the disclosure identifies an object adjacent to the transparent display, and displays a virtual object related to the object to match the corresponding real object, and thus the user can see the virtual object more realistically.

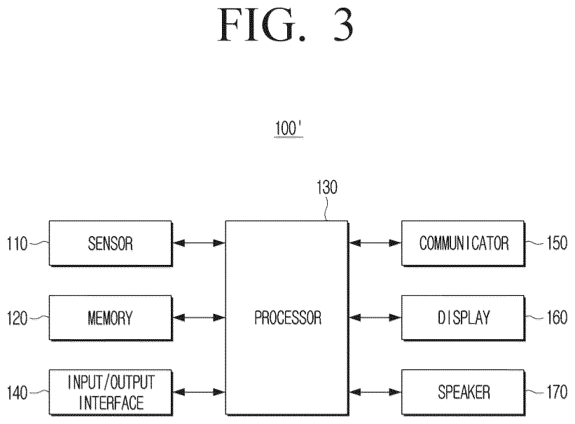

Meanwhile, in the above, only simple components constituting the electronic apparatus 100 were illustrated and explained, but in actual implementation, various components can be additionally included. Explanation in this regard will be described below with reference to FIG. 3.

FIG. 3 is a block diagram illustrating a configuration of a transparent display according to one or more embodiments of the disclosure.

Referring to FIG. 3, an electronic apparatus 100′ may include a sensor 110, memory 120, a processor 130, an input/output interface 140, a communicator 150, a display 160, and a speaker 170.

As the configurations of the sensor 110, the memory 120, and the processor 130 were explained in FIG. 2 above, only operations different from FIG. 2 will be explained below.

The input/output interface 140 may be any one interface among a high definition multimedia interface (HDMI), a mobile high-definition link (MHL), a universal serial bus (USB), a display port (DP), Thunderbolt, a video graphics array (VGA) port, an RGB port, a D-subminiature (D-SUB), and a digital visual interface (DVI).

The input/output interface 140 may input or output at least one of an audio signal or a video signal. Depending on implementation examples, the input/output interface 140 may include a port inputting and outputting only audio signals and a port inputting and outputting only video signals as separate ports, or it may be implemented as one port that inputs and outputs both audio signals and video signals.

Also, the input/output interface 140 may provide a video signal corresponding to a screen generated at the electronic apparatus 100′ or an audio signal together with the video signal to an external apparatus (e.g., a display apparatus, an STB, etc.).

The communicator 150 is a component that performs communication with various types of external apparatuses according to various types of communication methods. The communicator 150 may include a Wi-Fi module, a Bluetooth module, an infrared communication module, and a wireless communication module, etc. Here, each communication module may include at least one hardware chip or hardware circuit.

A Wi-Fi module and a Bluetooth module may perform communication by a Wi-Fi method and a Bluetooth method, respectively. In the case of using a Wi-Fi module or a Bluetooth module, various types of connection information such as an SSID and a session key, etc. is transmitted and received first, and connection of communication is performed by using the information, and various types of information can be transmitted and received thereafter.

An infrared communication module performs communication according to an infrared Data Association (IrDA) technology of transmitting data to a near field wirelessly by using infrared rays between visible rays and millimeter waves.

A wireless communication module may include at least one communication chip that performs communication according to various wireless communication protocols such as Zigbee, 3rd Generation (3G), 3rd Generation Partnership Project (3GPP), Long Term Evolution (LTE), LTE Advanced (LTE-A), 4th Generation (4G), 5th Generation (5G), etc. other than the aforementioned communication methods.

Other than the above, the communicator 150 may include at least one of a local area network (LAN) module, an Ethernet module, or a wired communication module that performs communication by using a pair cable, a coaxial cable, an optical fiber cable, or an ultra wide-band (UWB) module, etc.

According to one or more embodiments, the communicator 150 may use the same communication module (e.g., a Wi-Fi module) to communicate with an external apparatus such as a remote control and an external server.

According to another embodiment, the communicator 150 may use different communication modules (e.g., a LTE module) for communicating with an external apparatus such as a remote control and an external server. For example, the communicator 150 may use at least one of an Ethernet module or a Wi-Fi module for communicating with an external server, and use a BT module for communicating with an external apparatus such as a remote control. However, this is merely an example, and the communicator 150 may use at least one communication module among various communication modules in the case of communicating with a plurality of external apparatuses or external servers.

The communicator 150 may receive contents. Such contents may be diverse like a movie, a music video, a drama, a shorts image, etc. Also, although it is assumed that a content is a video, it may be an image, and may also be referred to as a moving image.

In addition, the communicator 150 may receive not only contents, but also information necessary for providing various types of applications and services of the electronic apparatus 100 from an external apparatus.

The display 160 may display an image in a state wherein an object is seen through transparently. For example, the display 160 may be implemented in various types such as a transparent liquid crystal display (LCD) type, a transparent thin-film electroluminescent panel (TFEL) type, a transparent OLED type, a projection type, a transparent LED type, etc. Hereinafter, various embodiments regarding the configuration of the display 160 will be explained.

A transparent LCD type means a transparent display apparatus that was implemented by removing a backlight unit from an LCD device that is currently being used, and using a pair of polarizing plates, an optical film, a transparent thin film transistor, a transparent electrode, etc. In a transparent LCD device, permeability deteriorates by polarizing plates or an optical film, etc., and light efficiency deteriorates as an ambient light is used instead of a backlight unit, but there is an advantage that a large size transparent display can be implemented. A transparent TFEL type means a device using an AC type inorganic thin film EL display (AC-TFEL) consisting of a transparent electrode, an inorganic phosphor, and an insulating film. An AC-TFEL is a display wherein accelerated electrons inside an inorganic phosphor excite the phosphor as they pass by, and thereby make the phosphor emit a light. In case the display 160 is implemented in a form of a TFEL, the processor 130 may determine a location to display information by adjusting such that electrons are projected on an appropriate location. As the inorganic phosphor and the insulating film have a transparent property, a very transparent display can be implemented.

Other than the above, a transparent OLED type means a transparent display apparatus using OLEDs that can emit a light by themselves. As an organic light emitting layer is transparent, if electrodes on both sides are used as transparent electrodes, the apparatus can be implemented as a transparent display apparatus. OLEDs get to emit a light as electrons and holes are injected on both sides of an organic light emitting layer, and they are coupled within the organic light emitting layer. A transparent OLED device displays information by injecting electrons and holes into a desired location by using such a principle.

In a transparent micro LED type, pixels constituting the micro LEDs are arranged in a minimum size, and the remaining space is made into an opening part, and the apparatus can thereby be implemented as a transparent display apparatus. Also, as the micro LEDs are of a self-luminous type, when compared to the aforementioned transparent OLED type, if a contrast ratio is high, they may have higher brightness than the transparent OLED type.

The speaker 170 may output a sound. Specifically, the speaker 170 may be a component that outputs not only various types of audio data processed at the input/output interface, but also various types of notification sounds or voice messages, etc. Also, the speaker 170 may output result information corresponding to a voice recognition operation that will be described below. Meanwhile, the speaker 170 as above may be a speaker that operates while being located on the frame, or being attached to the display.

Also, the speaker 170 may output a sound corresponding to an object displayed on the transparent display. For example, in case an animal (e.g., a cat) is displayed on the transparent display, the processor 130 may control the speaker 170 such that a meowing sound of a cat is output.

Meanwhile, in FIG. 3, it was illustrated and explained that the electronic apparatus 100′ includes the display 160, but if the electronic apparatus 100′ is an apparatus not including a display such as a set top box, the display can be omitted. Also, depending on implementation forms, the aforementioned speaker can also be omitted. Further, other components (e.g., a microphone, a camera, etc.) may be further included.

FIG. 4 is a diagram for illustrating a method of generating masking information according to one or more embodiments of the disclosure. Specifically, FIG. 4 is a diagram for illustrating an operation of generating masking information for a real object within a frame.

Referring to FIG. 4, the transparent display may be located in the center or the inside of a frame constituting a hexahedron. Specifically, as a recent display has very thin thickness, the display can be implemented to be thin in case it is fixed on a wall surface, but a frame as in FIG. 4 is required to arrange it in a general space.

That is, in case the transparent display according to the disclosure is arranged on a wall surface such as a window or a door, a frame may not be used. Alternatively, in contrast, a frame of a window or a door as described above can be seen as the frame according to the disclosure.

In case a frame is used as illustrated, it is difficult to identify an object adjacent to the transparent display through an image that photographed the rear side direction of the transparent display.

Accordingly, in the illustrated example, the electronic apparatus 100 may obtain images for the inner space by using cameras located in the upper part, the left side, and the right side of the frame, and obtain ambient information including a real object 10 located in the space inside the frame by using the obtained images. Here, the cameras may be cameras that are generally used, or three-dimensional cameras that can obtain distance information, etc.

Here, the cameras may be located to be toward the inner direction in each location, and also photograph the rear side direction by varying the photographing direction. Also, depending on cases, only one to two cameras may be used, or cameras in a more number than the number of the illustrated cameras may be used.

Also, in actual implementation, it is also possible to use a separate distance sensor other than cameras.

If an image for the space inside the frame is obtained through cameras as above, the electronic apparatus 100 may identify an object on the inside by using the obtained image. If it is identified that there is no object on the inside, the electronic apparatus 100 may not perform a separate operation. Here, not performing a separate operation means not displaying a virtual object related to a real object, but an operation of displaying any image on the transparent display may be performed.

In case it was identified that there is an object on the inside, the electronic apparatus 100 may perform a recognizing operation for the object on the inside. Here, the electronic apparatus 100 may identify the type of the object, and obtain information on whether the object is located on the front side of the transparent display, or located on the rear side, and the distance between each display and the object, and information on the shape of the object.

When the information on the shape of the object is obtained, the electronic apparatus 100 may obtain a masking layout 400 based on the distance information identified earlier. Within such a masking layout 400, the real object 10 may have a location and a shape 410 in a case wherein it was projected on the transparent display.

That is, in the aforementioned process, the size of an object, etc. is obtained based on the location of the camera, but for an actual user, the size of the object in the space of the transparent display is important, and in a process of synthesizing an image in a virtual object that will be described below, the space occupied by the real object on the transparent display is also important. That is, the electronic apparatus 100 may obtain a masking layout having a scaled shape 20 by reflecting the distance information identified at the sensor to the identified layout.

For example, in the case of an object that is very adjacent to the transparent display, the scale value may be close to 1, but if the separated distance from the transparent display is big, the scale value may be somewhat different from 1. In this case, the scale value may be bigger than 1 or smaller than 1 according to whether the object is located on the front side of the transparent display, or located on the rear side.

It can be figured out that the masking layout generated in accordance thereto corresponds to an area occupied by the real object on the transparent display.

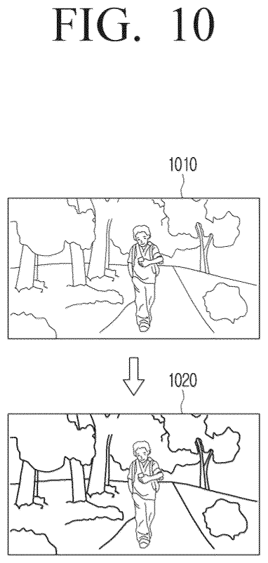

Meanwhile, in the illustrated example, explanation was described by assuming that the inside area of a real image is used as masking information, but in actual implementation, a form of using an outside area of a real image is also possible. A case of using an outside area will be described later in FIG. 10.

Meanwhile, the electronic apparatus 100 may include a camera that photographs the rear side of the transparent display, and obtain information on the rear side by using an image photographed at the included camera.

Then, the electronic apparatus 100 may recognize an object for which masking information will be obtained in the obtained rear side information, and in case there is no object to be recognized, the electronic apparatus 100 may end the operation. Here, the electronic apparatus 100 may perform object recognition for the entire areas of the image, or perform object recognition for only some areas (e.g., a central area) of the image. For such object recognition, a learning model may be used.

If an object for which masking information needs to be obtained is recognized, the electronic apparatus 100 may obtain shape and distance information corresponding to the object, and generate masking information based on the shape and the distance. That is, such an operation is identical to the operation explained earlier and only the source of the obtained image is different, and thus overlapping explanation will be omitted.

If masking information is generated as above, in the processes afterwards, image synthesis, etc. needs to proceed in consideration of only the masking information in a process of generating and merging a virtual object. That is, in 3D modeling, a task requiring a lot of resources is not used, but only image processing in a 2D unit may be used.

Meanwhile, in FIG. 4, it was illustrated and explained that the aforementioned operation is performed in case an object is located within the frame space, but the aforementioned operation may be performed in case an object is located outside the frame space.

For example, in case an object is located in the front part or the rear part of the frame space, if the object is arranged to be very adjacent to the frame, it may be difficult to identify the object located outside the frame through the camera photographing the rear side. In such a case, masking information may also be generated through the method explained above.

Also, in the illustrated example, it was illustrated and explained that ambient information is obtained by using a camera located on the frame, etc., but a camera may not be located on the frame, but may be located in a separated location, or in a location physically distinguished from the electronic apparatus 100.

In addition, in the illustrated example, it was illustrated and explained that the sensor is for a use of identifying an object on the inside, etc., but in actual implementation, the location of the user may be identified by using the illustrated sensor, or using an additional sensor.

For example, the electronic apparatus 100 may generate masking information as described above in consideration of the location of the user. For example, in each of a case wherein the user is located on the front side and a case wherein the user is located on the left on the front side, a location on which a real object is projected on the transparent display may vary. Accordingly, the electronic apparatus 100 may generate masking information wherein a shape of an object is located in a projection location of a real object in consideration of the location of the user.

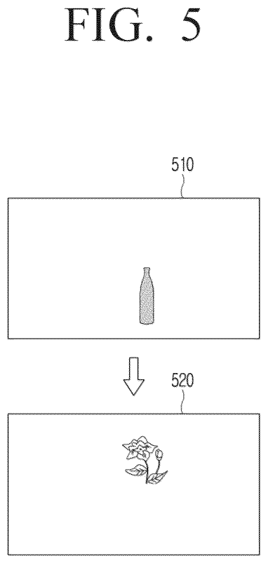

FIG. 5 is a diagram for illustrating a method of displaying a virtual object based on a real object according to one or more embodiments of the disclosure.

Referring to FIG. 5, a masking layout 510 and a virtual layout image 520 are illustrated.

The masking layout 510 is a layout that was formed as distance information was reflected to a layout shape corresponding to a shape for a real object, as illustrated in FIG. 4 above.

Such a layout shape corresponds to an area occupied by a real object on the transparent display as explained above. Thus, the electronic apparatus 100 may use the masking layout 510 in a process of rendering an image corresponding to a virtual object image.

For example, as illustrated in the drawing, in case the real object is a flowerpot (or a vase), and a virtual object to be displayed correspondingly was determined as a flower, a sense of unity may be expressed when the flower object is displayed to extend from the opening of the flowerpot.

Accordingly, the electronic apparatus 100 may identify the opening area of the vase in the masking layout 510, and render a flower image wherein the stem of the flower is located in the opening area, and the sepal of the flower, etc. is located in the upper area of the opening. Here, the electronic apparatus 100 may render the flower image in consideration of the location of the user.

For example, in case the electronic apparatus 100 has a 3D model for the flower, the electronic apparatus 100 may render the flower image in consideration of the location of the user. Accordingly, in case the user moves from the left side to the right side in the upper part of the transparent display, the viewpoint of the shape of the flower displayed gradually changes, and thus the user can see a more realistic image.

Here, rendering may be an operation of processing an image. Rendering may include an image processing operation of applying an intended image effect by processing a 2D or 3D image. Rendering may include an operation of generating an image or a model of a specific dimension. Rendering may include an operation of visually expressing an object or an element. Rendering may include an operation of visually expressing the location, the size, the shape, the form, the color, the texture, etc. of an object.

For example, rendering may include 2D rendering, 3D rendering, a visual effect, simulation, image synthesis, image generation, etc.

The rendering in the disclosure proceeds in a 2D space but not a 3D space, and thus it may proceed with relatively low resources. Meanwhile, in actual implementation, a rendering operation may be performed by assuming a 3D space.

A virtual object image generated as above may be displayed on the transparent display, and accordingly, the user can see an image wherein a flower is located on a real flowerpot.

Meanwhile, in the illustrated example, it was illustrated and explained that a static virtual object is displayed on a static real object, but in actual implementation, a virtual object may be dynamic. Explanation in this regard will be described later with reference to FIG. 6 and FIG. 7.

FIG. 6 is a diagram for illustrating a method of displaying a virtual object based on a real object according to one or more embodiments of the disclosure.

Referring to FIG. 6, a masking layout 610, a virtual object image 620, and a screen 630 viewed by an actual user are illustrated.

The masking layout 610 is a layout that was formed as distance information was reflected to a layout shape corresponding to a shape for a real object, as illustrated in FIG. 4 above.

Such a layout shape corresponds to an area occupied by a real object on the transparent display as explained above. Thus, the electronic apparatus 100 may use the masking layout 610 in a process of rendering an image corresponding to a virtual object image.

For example, as illustrated in the drawing, in case the real object is a flowerpot, and virtual objects to be displayed correspondingly were determined as a flower and a cat, a sense of unity may be expressed when the flower object is displayed to extend from the opening of the flowerpot. Also, the cat may be rendered to move from a location corresponding to the bottom line of the flowerpot.

Here, as the cat is a dynamic object, the electronic apparatus 100 may render the moving cat, and determine whether the cat moves in front of the flowerpot, or moves behind the flowerpot.

For example, in a case as illustrated in FIG. 6, the image is rendered by assuming that the cat object is near to the user, and thus a rendering image may be generated in consideration of the value. Also, a rendering image may be generated such that the cat moves in a location coinciding with the bottom surface of the flowerpot or a location lower than that, so that it can look as if the bottom surface coincides.

Meanwhile, such an object may be a content generated through rendering, or an object generated by photographing a real cat. Even in the case of a content that was generated by photographing a real cat, the cat is displayed on the current transparent display apparatus, but a real cat is not moving around the vase, and thus the object is also referred to as a virtual object.

When a virtual object image 620 generated as above is provided to the transparent display, it may be illustrated that a cat is walking in front of the vase as in the screen 730 viewed by the actual user.

Meanwhile, in the above, it was assumed that the cat passes by in front of the vase, but the cat may pass by behind the vase. Explanation in this regard will be described below with reference to FIG. 7.

FIG. 7 is a diagram for illustrating a method of displaying a virtual object based on a real object according to one or more embodiments of the disclosure.

Referring to FIG. 7, a masking layout 710, a virtual object image 720, and a screen 730 viewed by an actual user are illustrated.

The masking layout 710 is a layout that was formed as distance information was reflected to a layout shape corresponding to a shape for a real object, as illustrated in FIG. 4 above.

Such a layout shape corresponds to an area occupied by a real object on the transparent display as explained above. Thus, the electronic apparatus 100 may use the masking layout 710 in a process of rendering an image corresponding to a virtual object image.

In the case illustrated in FIG. 7, the image is rendered by assuming that the cat walks behind the flowerpot, and thus a rendering image may be generated in consideration of the value. For example, considering that the cat is distanced farther than the flowerpot, the cat may be rendered by reducing its size more than in the case in FIG. 6. Also, for the path that the cat passes by, a rendering image wherein it looks as if the cat moves in a part slightly upper than the bottom surface of the flowerpot may be generated.

When the virtual object image 720 generated as above is provided to the transparent display, it may be illustrated that a cat is walking behind the vase as in the screen 630. Here, regarding an area wherein the virtual object and the real object partially overlap as illustrated in the drawing, the electronic apparatus 100 may make the overlapping area of the virtual object not displayed.

Meanwhile, in the above, it was illustrated and explained that an overlapping area is processed in an actual application process, but in actual implementation, an image may not be made to be rendered for an area within a masking layout in a rending process of a virtual object.

Meanwhile, in the above, a case wherein a real object is fixed, and a virtual object is also fixed or is moved was assumed, but in actual implementation, a real object may not be fixed, either.

For example, in case the user moves a vase, the flower on the vase may move correspondingly to the movement of the vase. Also, an operation that the flower shakes, or petals fall, etc. may be created according to the moving speed, and provision of a more realistic content is thereby possible.

Also, in case a real cat moves around the transparent display on the contrary to the above, it is also possible to display a cat toy around the real cat as a virtual object, and display the location of the cat toy, etc. variably correspondingly to the movement of the cat.

Meanwhile, in the above, explanation was described by assuming a case wherein a real object is located in a space inside the frame, but a real environment may be a background area. Explanation in this regard will be described below with reference to FIG. 8 to FIG. 11.

FIG. 8 to FIG. 11 illustrate embodiments wherein the transparent display is used as a filter for a real environment. Specifically, FIG. 8 is a diagram for illustrating one or more embodiments wherein mask information is utilized as filter information according to one or more embodiments of the disclosure.

Referring to FIG. 8, a photographed rear side image 810, a virtual object image 820, and a screen 830 viewed by an actual user are illustrated.

The photographed rear side image 810 may be an image that was obtained by photographing the rear side direction of the transparent display. If a flower is identified in such an image, the electronic apparatus 100 may identify that the flower is the real object.

However, there may be a case wherein some flowers withered, or the color is not the color desired by the user. In this case, if the user is made to display the preferred color, the satisfaction of the user can be improved.

For such an operation, the electronic apparatus 100 may generate an area to which color correction will be applied in the generated image as masking information. Then, the electronic apparatus 100 may include the color information to be applied to the area as the masking information.

For example, the electronic apparatus 100 may generate an area wherein color correction is necessary as masking information, and display a predetermined color in the generated masking area, and thereby enable the user to see the intended color through overlapping of the displayed color and the real color.

The electronic apparatus 100 may generate the virtual object image 820 based on such masking information. Such a virtual object image does not render a specific object, unlike what was illustrated above, but may be identical to a specific color filter.

When the virtual object image 820 formed as such a color filter is displayed on the transparent display, the user can identify the flower having a color changed from the color of the real flower through the transparent display.

In the above, a virtual object was utilized as a color filter for the use of correcting the color of a real object, but in actual implementation, a virtual object may also be used as a use for improving not only the color, but also the brightness, the texture, etc.

As the transparent display is used as a correction filter of a real object, the user can experience an image wherein various kinds of image processing for a real object was performed. Such a filter regarding a real environment may be applied not only to a filter regarding a color as illustrated in FIG. 8, but also to chroma, brightness, etc. Also, the filter may be applied to a shape and texture.

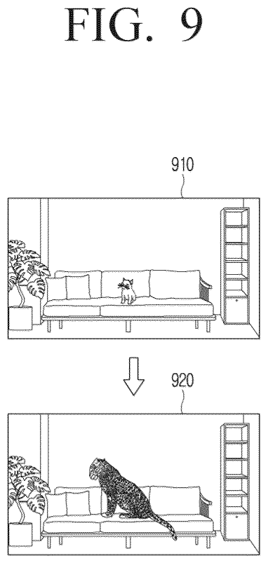

FIG. 9 is a diagram for illustrating one or more embodiments of utilizing masking information as filter information according to one or more embodiments of the disclosure.

Referring to FIG. 9, a photographed rear side image 910 and a screen 920 viewed by an actual user are illustrated.

An animal may be located on the rear side of the transparent display as illustrated. In case an animal is located as above, the electronic apparatus 100 may obtain information that there is an animal on the rear side, the located area of the animal, etc. through object recognition. As explained earlier, the electronic apparatus 100 may generate a masking area corresponding to the animal.

Meanwhile, in the illustrated example, a virtual object was generated to be distinguished from a real object, but FIG. 9 is a case wherein a real object is replaced by a virtual object. For example, if a cat is detected as illustrated, a different animal such as a leopard may be made to be displayed instead of the cat.

For this, the electronic apparatus 100 may render a virtual object corresponding to the leopard. Here, in order that the cat which is the real object is not displayed, a virtual object which makes the real object entirely covered, i.e., which makes the object shape within the masking layout entirely covered may be rendered.

Also, in this case, the electronic apparatus 100 may also recognize a sofa on which the cat is located, and perform the aforementioned rendering such that the rendered leopard is located on the sofa.

When such an image wherein the leopard is rendered is displayed on the transparent display, the user can see that the leopard is located on the sofa instead of the cat as in the screen 920.

Meanwhile, in the illustrated example, a form wherein a main object is replaced is illustrated, but in actual implementation, a form wherein a main object is maintained, and an ambient object or the ambient environment is varied is also possible. Explanation in this regard will be described below with reference to FIG. 10.

FIG. 10 is a diagram for illustrating one or more embodiments of utilizing masking information as filter information according to one or more embodiments of the disclosure.

Referring to FIG. 10, a photographed rear side image 1010 and a screen 1020 viewed by an actual user are illustrated.

A person may be located on the rear side of the transparent display as illustrated. In case a person is located as above, the electronic apparatus 100 may obtain information that there is a person on the rear side and the location information of the person through object recognition.

In this case, the electronic apparatus 100 may exert an effect as if the person is located in a distorted space but not a real space, by applying a 3D effect to the ambient space of the person.

For this, the electronic apparatus 100 may generate masking information having a layout for the ambient space excluding the person, and set that a 3D effect is applied to the masking area.

For example, as illustrated in the drawing, the electronic apparatus 100 may render a virtual object that makes the lines of the ambient space displayed to be thick, or makes the colors displayed to be distinguished.

When a virtual object for which the lines or the colors of the ambient space were distinguished as above is displayed on the transparent display, the user can see that the space around the person is distorted as in the screen 1020.

Meanwhile, in the illustrated example, one or more embodiments wherein a distortion effect was granted only to an ambient space excluding a person was illustrated, but in actual implementation, a distortion effect can be granted to a person, and in that case, it may be a form wherein a first 3D effect is applied to the area wherein the person is located, and a second 3D effect is applied to the ambient area. For example, an effect as if the user is wearing a hat even though the user is not wearing a hat may be granted, or an effect as if the user is wearing different clothes from the clothes the user is wearing may be granted.

That is, the 3D effect illustrated in FIG. 10 is merely an example, and in actual implementation, various effects that were not illustrated may be applied.

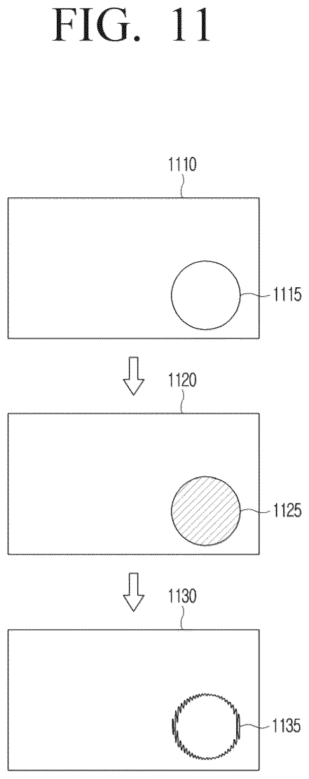

FIG. 11 is a diagram for illustrating one or more embodiments of utilizing masking information as filter information according to one or more embodiments of the disclosure. Specifically, FIG. 11 is an illustrated example of a case wherein the transparent display operates as if it is a bumpy window.

Referring to FIG. 11, in case a ball is arranged to be adjacent to the rear side of the transparent display, an image 1110 wherein the ball 1115 is located may be obtained.

Through such an image, a masking layout image having the layout of the ball 1125 may be obtained.

As such a masking layout falls under a case wherein the transparent display operates as if it is a bumpy window, as explained above, a virtual object image to which an image processing effect that expresses as if a real ball is located on the rear side of the bumpy window is applied may be generated.

Accordingly, if such a virtual object image is displayed on the transparent display, the user gets to have an optical illusion that the ball located on the rear side of the transparent display is not slick, but looks as if it is bumpy.

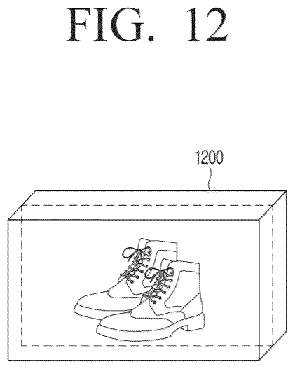

Meanwhile, in the above, it was illustrated and explained that a virtual object is displayed by utilizing a real object, but in actual implementation, a virtual object may be displayed without utilizing a real object. Explanation in this regard will be described below with reference to FIG. 12.

FIG. 12 is a diagram for illustrating an operation of displaying a 3D content according to one or more embodiments of the disclosure.

Referring to FIG. 12, a virtual object is displayed. Specifically, the virtual object is a 2D image that was generated by using 3D data, and was displayed on the transparent display. Here, the electronic apparatus 100 may arrange the virtual object by distancing it from the bottom surface by greater than or equal to a specific height.

Also, the electronic apparatus 100 may change a viewpoint displayed per predetermined time point, and may thereby give an illusion that the virtual object is floating in the air and rotating.

Here, the virtual object used may be a 3D object that was generated by photographing a real object in various directions and performing 3D modeling, and may be a virtual 3D model as in a game.

Also, in a process of displaying an image corresponding to the aforementioned virtual object on the transparent display, the electronic apparatus 100 may display the image more stereoscopically by inserting a shadow in the lower part of the aforementioned virtual object, or applying a shadow or screen brightness corresponding to the ambient object by using background information, etc.

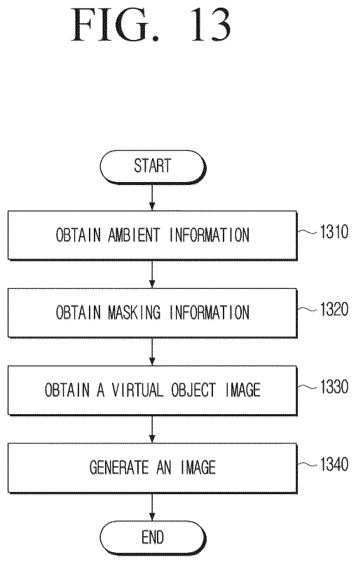

FIG. 13 is a flow chart for illustrating a method for controlling an electronic apparatus according to one or more embodiments of the disclosure.

Referring to FIG. 13, ambient information of the transparent display is obtained (1310). For example, regarding an object located within a frame supporting the transparent display, ambient information may be obtained by using an image obtained from a camera that is arranged in at least one location among the upper part, the left side surface, and the right side surface of the frame, and photographs an image in the direction of the center part. Also, ambient information regarding the rear side direction of the transparent display may be obtained by photographing the rear side direction of the transparent display. Meanwhile, in actual implementation, only information for a partial space among two spaces may be obtained, or information for both of the two spaces may be obtained.

Then, masking information corresponding to a real object adjacent to the transparent display is obtained based on the ambient information (1320). For example, the electronic apparatus may identify a real object for which masking information will be obtained by using a photographed image. Here, the electronic apparatus may perform an object recognition process by using objection recognition, etc., and if an object of a predetermined type is recognized, the electronic apparatus may select an object for which masking information will be obtained based on the location of the recognized object.

Then, the electronic apparatus may obtain a layout image corresponding to the shape of a real object, and obtain a masking layout by scaling the layout image based on size information of the real object seen on the transparent display.

Here, the electronic apparatus may identify a real object for which masking information will be obtained by using a photographed image, and obtain layout information corresponding to the shape of the identified real object. Through this process, the electronic apparatus may obtain information on the type and the shape, etc. for the real object adjacent to the transparent display. Also, the electronic apparatus may obtain location information for the object. For example, the electronic apparatus may obtain distance information such as whether the object is located on the front side of the transparent display, or located on the rear side, and by how much distance the object is distanced from the front side, etc.

Then, the electronic apparatus obtains a virtual object image to be displayed on the transparent display (1330). For example, the electronic apparatus may obtain a virtual object image corresponding to the identified real object.

For example, if the adjacent real object is a flowerpot, the electronic apparatus may obtain a virtual object image related to a flower as a virtual object. Also, if the adjacent real object is a fish bowl, fish may be used as a virtual object. However, these are merely examples, and in actual implementation, a plurality of virtual objects but not one virtual object may be used.

Then, if movement of the real object is identified, the electronic apparatus may obtain a virtual object image wherein at least one of the location or the shape of the virtual object is changed based on information on the identified movement of the real object.

For example, if the real object is a cat, the virtual object may be a cat toy. In this case, the virtual object may move in the same direction correspondingly to the direction in which the cat moves. Alternatively, in case the real flowerpot moves, the electronic apparatus may move the flower object correspondingly to the movement of the flowerpot. Also, the electronic apparatus may create a situation wherein petals flutter or fall, etc. correspondingly to the moving direction and speed.

Then, the electronic apparatus may obtain masking information corresponding to a color area having predetermined color information in the real object, and obtain a color filter image that makes the color area of the virtual object image seen in a different color from the color information.

If the masking information is an ambient area excluding a predetermined real object, the electronic apparatus may obtain an event image wherein an effect of applying a predetermined image filter to the ambient area exists by using the masking information.

Also, the electronic apparatus may obtain an even image wherein an effect of applying a predetermined image filter to the object area exists by using the masking information.

Then, the electronic apparatus generates an image to be displayed on the transparent display by correcting the shape of the virtual object image based on the masking information (1340). For example, the electronic apparatus may generate an image in a form wherein a virtual object is arranged to be connected from a predetermined location of the real object based on the masking information. Then, the electronic apparatus may generate an image wherein the size of the virtual object was adjusted based on the arrangement form of the virtual object and the real object.

For example, as explained in FIG. 6 and FIG. 7, the electronic apparatus may change the size of the virtual object according to whether the display location of the virtual object is the front side or the rear side of the real object.

Then, in case the virtual object is arranged behind the real object, the electronic apparatus may generate an image wherein an area in the virtual object overlapping with the real object is not displayed.

Then, when the aforementioned image is generated, the electronic apparatus may provide the generated image (or display image) to the transparent display. Meanwhile, in actual implementation, the electronic apparatus may be an apparatus distinguished from the transparent display apparatus. In this case, the image generated through the aforementioned process may be transmitted to the transparent display apparatus.

As described above, in the controlling method according to the disclosure, a virtual object is displayed by utilizing an object located around a transparent display apparatus, and thus a more realistic content can be displayed. Also, as masking information is used in the aforementioned process, the electronic apparatus can perform tasks such as image synthesis, etc. with lower resources.

Meanwhile, the methods according to at least some of the aforementioned various embodiments of the disclosure may be implemented in forms of applications that can be installed on conventional electronic apparatuses.

Also, the methods according to at least some of the aforementioned various embodiments of the disclosure may be implemented just with software upgrade, or hardware upgrade of conventional electronic apparatuses.

In addition, the methods according to at least some of the aforementioned various embodiments of the disclosure may be performed through an embedded server provided on an electronic apparatus, or at least one external server of an electronic apparatus.

Meanwhile, according to one or more embodiments of the disclosure, the aforementioned various embodiments may be implemented as software including instructions stored in machine-readable storage media, which can be read by machines (e.g.: computers). The machines refer to apparatuses that call instructions stored in a storage medium, and can operate according to the called instructions, and the apparatuses may include an apparatus according to the aforementioned embodiments (e.g.: an electronic apparatus A). In case an instruction is executed by a processor, the processor may perform a function corresponding to the instruction by itself, or by using other components under its control. The at least one instruction may be executed by the at least one processor individually or collectively to cause the electronic apparatus to perform operations described herein. An instruction may include a code that is generated or executed by a compiler or an interpreter. A storage medium that is readable by machines may be provided in the form of a non-transitory storage medium. Here, the term ‘a non-transitory storage medium’ only means that a storage medium is a tangible apparatus, and does not include signals (e.g.: electromagnetic waves), and the term does not distinguish a case wherein data is stored in the storage medium semi-permanently and a case wherein data is stored temporarily. For example, ‘a non-transitory storage medium’ may include a buffer wherein data is temporarily stored. Also, according to one or more embodiments, the method according to the various embodiments disclosed herein may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or distributed on-line (e.g.: download or upload) through an application store (e.g.: Play Store™) or directly between two user devices (e.g.: terminal devices). In the case of on-line distribution, at least a portion of a computer program product (e.g.: a downloadable app) may be stored in a storage medium that is readable by machines such as the server of the manufacturer, the server of the application store, and the memory of the relay server at least temporarily, or may be generated temporarily.

Also, the various embodiments of the disclosure may be implemented as software including instructions stored in machine-readable storage media, which can be read by machines (e.g.: computers). The machines refer to apparatuses that call instructions stored in a storage medium, and can operate according to the called instructions, and the apparatuses may include an electronic apparatus according to the aforementioned embodiments (e.g.: an electronic apparatus 100).

In case an instruction is executed by a processor, the processor may perform a function corresponding to the instruction by itself, or by using other components under its control. An instruction may include a code that is generated or executed by a compiler or an interpreter

Also, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed is:

1. An electronic apparatus comprising:
a sensor configured to obtain ambient information of a transparent display;
memory configured to store at least one instruction; and
at least one processor, wherein the at least one instruction, when executed by the at least one processor individually or collectively, causes the electronic apparatus to:
obtain masking information corresponding to a real object adjacent to the transparent display based on the ambient information;
obtain a virtual object image to be displayed on the transparent display;
generate a display image to be displayed on the transparent display by correcting a shape of the virtual object image based on the masking information; and
output the display image to the transparent display.

2. The electronic apparatus of claim 1, wherein the at least one instruction, when executed by the at least one processor individually or collectively, further causes the electronic apparatus to:
identify a type of the real object; and
obtain the virtual object image corresponding to the type.

3. The electronic apparatus of claim 1, wherein the at least one instruction, when executed by the at least one processor individually or collectively, further causes the electronic apparatus to:
identify movement of the real object; and
obtain the virtual object image in which at least one of a location or the shape of a virtual object is changed based on the movement of the real object.

4. The electronic apparatus of claim 1,
wherein the sensor comprises:
a camera configured to image a rear side of the transparent display, and
wherein the at least one instruction, when executed by the at least one processor individually or collectively, further causes the electronic apparatus to:
identify the real object for which the masking information will be obtained by using an image taken at the camera; and
obtain layout information corresponding to a shape of the real object.

5. The electronic apparatus of claim 1,
wherein the sensor comprises:
a camera on at least one of an upper part, a left side surface, or a right side surface of the transparent display, and takes an image in a direction of a center part of the transparent display, and
wherein the at least one instruction, when executed by the at least one processor individually or collectively, further causes the electronic apparatus to:
identify the real object located within a frame space supporting the transparent display, and obtain layout information corresponding to a shape of the real object.

6. The electronic apparatus of claim 1, wherein the at least one instruction, when executed by the at least one processor individually or collectively, further causes the electronic apparatus to:
obtain a layout image corresponding to a shape of the real object; and
obtain a masking layout by scaling the layout image based on size information of the real object.

7. The electronic apparatus of claim 1, wherein the at least one instruction, when executed by the at least one processor individually or collectively, further causes the electronic apparatus to:
generate the display image with a virtual object extending from a location of the real object based on the masking information.

8. The electronic apparatus of claim 1, wherein the at least one instruction, when executed by the at least one processor individually or collectively, further causes the electronic apparatus to:
generate the display image with a size of a virtual object adjusted based on an arrangement of the virtual object and the real object.

9. The electronic apparatus of claim 1, wherein the at least one instruction, when executed by the at least one processor individually or collectively, further causes the electronic apparatus to:
based on a virtual object being arranged behind the real object, generate the display image with an area in the virtual object overlapping with the real object not displayed.

10. The electronic apparatus of claim 1, wherein the at least one instruction, when executed by the at least one processor individually or collectively, further causes the electronic apparatus to:
obtain the masking information corresponding to a color area having color information of the real object; and
obtain a color filter image that makes the color area of the virtual object image appear a different color from the color information.

11. The electronic apparatus of claim 1,
wherein the masking information comprises area information where the virtual object image is displayed, and the area information is an ambient area excluding the real object, and
wherein the at least one instruction, when executed by the at least one processor individually or collectively, further causes the electronic apparatus to:
obtain an event image with an image filter applied to the ambient area using the masking information.

12. The electronic apparatus of claim 1,
wherein the masking information comprises area information where the virtual object image is displayed, and the area information is an object area comprising the real object, and
wherein the at least one instruction, when executed by the at least one processor individually or collectively, further causes the electronic apparatus to:
obtain an event image with an image filter applied to the object area using the masking information.

13. The electronic apparatus of claim 1, further comprising:
the transparent display,
wherein the at least one instruction, when executed by the at least one processor individually or collectively, further causes the electronic apparatus to:
control the transparent display to display the display image.

14. A method for controlling an electronic apparatus, the method comprising, using at least one processor:
obtaining ambient information of a transparent display from a sensor;
obtaining masking information corresponding to a real object adjacent to the transparent display based on the ambient information;
obtaining a virtual object image to be displayed on the transparent display;
generating a display image to be displayed on the transparent display by correcting a shape of the virtual object image based on the masking information; and
outputting the display image to the transparent display.

15. A non-transitory computer-readable recording medium storing a program for executing a method for controlling an electronic apparatus, wherein the method comprises:
obtaining ambient information of a transparent display;
obtaining masking information corresponding to a real object adjacent to the transparent display based on the ambient information;
obtaining a virtual object image to be displayed on the transparent display;
generating a display image to be displayed on the transparent display by correcting a shape of the virtual object image based on the masking information; and
outputting the display image to the transparent display.

16. The method of claim 14, further comprising, using the at least one processor:
identifying a type of the real object; and
obtaining the virtual object image corresponding to the type.

17. The method of claim 14, further comprising, using the at least one processor:
identifying movement of the real object; and
obtaining the virtual object image in which at least one of a location or the shape of a virtual object is changed based on the movement of the real object.

18. The method of claim 14, wherein the sensor includes a camera configured to image a rear side of the transparent display, the method further comprising, using the at least one processor:
identifying the real object for which the masking information will be obtained by using an image taken at the camera; and
obtaining layout information corresponding to a shape of the real object.

19. The method of claim 14, wherein the sensor includes a camera on at least one of an upper part, a left side surface, or a right side surface of the transparent display, and takes an image in a direction of a center part of the transparent display, the method further comprising, using the at least one processor:
identifying the real object located within a frame space supporting the transparent display, and obtain layout information corresponding to a shape of the real object.

20. The method of claim 14, further comprising, using the at least one processor:
obtaining a layout image corresponding to a shape of the real object; and
obtaining a masking layout by scaling the layout image based on size information of the real object.
